(19) United States
(12) Patent Application Publication
(10) Pub. No.: US 2006/0293939 A1
(43) Pub. Date: Dec. 28, 2006

(54) DESIGN MANAGING MEANS, DESIGN TOOL AND METHOD FOR WORK BREAKDOWN STRUCTURE

(76) Inventors: Wei Sun, Beijing (CN); Zhong Tian, Beijing (CN); Xin Zhang, Beijing (CN); Sheng Ye, Beijing (CN)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(21) Appl. No.: 11/425,421

(22) Filed: Jun. 21, 2006

(30) Foreign Application Priority Data
Jun. 23, 2005 (CN) 200510079698.1

(51) Int. Cl. G05B 19/418

(52) U.S. Cl. 705/8

(57) ABSTRACT

A WBS design managing means in project management, comprising: a WBS tree-like architecture designing means for implementing graphical tree-like design of the work items included in a project and their relations, and mapping them into an enhanced WBS data structure; a WBS attribute editing means for defining and editing attributes of work items at each node of the tree-like architecture; and a WBS data managing means for storing and managing data constructed in accordance with said enhanced WBS data structure. The WBS design managing means may connect to a converter for converting said constructed data into the format required by a project management tool so as to input said structured data to the project management tool. Besides, there is provided an enhanced WBS design tool. The present invention makes the system design tool and project management tool be integrated, so that the system architect and the project management personal have more fluent channel for information exchange under the support of the present invention's tool, improving efficiency and accuracy of project management.

### TECHNICAL FIELD

The invention generally relates to the project development and management, and particularly to a design managing means for Work Breakdown Structure (WBS) as well as an enhanced WBS design tool that comprises such a managing means.

### TECHNICAL BACKGROUND

In project management, a project manager is responsible for the management of the project, and the main workflow and work content comprise: identifying the work breakdown structure (WBS) and related work items, dispatching the work items to appropriate teams or persons (developers) with right skills, and controlling the project to be performed according to a predetermined plan (schedule, content, cost). WBS divides the “deliverable” of the project into several easily managed elements in a layer-to-layer way from top to bottom (these elements constitute a tree map), so as to structurally organize and define the working range of the project. Breaking down a layer in WBS is a more detailed description to the item elements, herein a broken down element is called a work's specific item and the specific items at the lowest layer (leaf nodes of the tree map) are called work items. In order to facilitate statistics in each layer and identification, each element in the WBS is assigned a unique identifier and expressed in layer.

FIG. 1 shows an example of WBS in the prior art. The top layer (first layer) shown in FIG. 1 represents the project summary of the project, comprising: the time duration in total is 720 hours and the cost in total is 38,000 USD; the next layer (second layer) represents that the project is divided into three specific items, comprising designing phase, programming phase and testing phase. Furthermore, the specific items of the third layer in the figure comprise first designing phase and the second designing phase. For the work items, it can be seen from FIG. 1 that, for instance, the first designing phase comprises design task 1 that needs 80 hours and a cost of 4,000 USD; while the programming phase comprises two work items, that is, program task 1 and program task 2, wherein the program task 1 and 2 need 200 hours and a cost of 10,000 USD totally. Apparently, the cost of a father node is a sum of the costs needed by all his son nodes in the next layer.

In the development of an engineering project, usually following roles are included: architect, project manager and developer. The architect is responsible for designing the system (structure) of a project and planning the main components and their connection relations.

Generally, the architect would communicate with the project manager about specific work items (tasks), specifications and dependencies between these work items, required skills, quantities of resources and etc. The project manager will organize these pieces of information and integrate them into the project plan, and then dispatch the related work tasks to the appropriate developers. Obviously, the output of architect's design work usually should be an input to the project management process, and extensive communications between the architect and the project manager will be needed to ensure the reasonableness of the project plan.

Though there exist many tools to help system design and project management, all of them cannot solve above-mentioned problems effectively. For instance, Microsoft Project and WBSChartPro, well known by those skilled in the art, are mainly used for project management and may be used to design WBS; while Rational Rose and Microsoft Visio are mainly used for system design, but have no linkage with project management tools.

In the prior art, the objective of WBS is for a project manager to plan and breakdown a project. The WBS is mainly used by a project manager and there is no information input entry provided for system designers/architect. The data structure in WBS has no description on skill requirements for implementing the work tasks. For instance, a system architect can clearly identify that, for example, JAVA programmers in which level are required for certain task. However, it is difficult for a project manager to make such a judgment, though such information is extremely needed during the project management process.

In such a case, at present mostly non-constructed documents, such as that of MS Word, PowerPoint or email, and oral messages are used as a way for communication, so there is no effective way to make the architect's work breakdown design result to be an input of the project management plan. As a result, communications between the architect and the project manager cost much time and effort. The project manager has to collect information from various documents to perform plan design of the project management.

Thus, it will be beneficial to provide an enhanced WBS data structure in which skill requirements, resource requirements and others can be included. And thereby, it will also be beneficial if an enhanced WBS design tool is provided that may connect a system design tool and a project management tool so as to automatically produce data, based on an enhanced WBS data structure, usable for project management, in order to provide useful information to the project management tool more conveniently and reduce the time for the communications between the architect and the project manager.

### SUMMARY OF THE INVENTION

Therefore, the objective of the present invention is to overcome the drawbacks of above-mentioned prior art, making the system design tool and project management tool be integrated, so that the system structure architect and the project management personal have more fluent channel for information exchange under the support of the present invention's tool, improving efficiency and accuracy of project management.

According to an aspect of the present invention, there is provided a WBS design managing means in project management, comprising:

a WBS tree-like architecture designing means for implementing graphical tree-like design of the work items obtained in the designing phase of a project and their relations, and mapping them into an enhanced WBS data structure;

a WBS attribute editing means for defining and editing attributes of work items at each node of the tree-like architecture; and

a WBS data managing means for storing and managing data constructed in accordance with said enhanced WBS data structure.

According to another aspect of the present invention, there is provided an enhanced WBS design tool comprising above-mentioned WBS design managing means and further comprising:

a converter for converting said constructed data into a format required by the project management tool so as to input said constructed data into the project management tool.

According to another aspect of the present invention, there is provided a system for project design and management comprising above-mentioned enhanced WBS design tool and further comprising:

a system design tool for making system design of said project so as to produce at least one said work item, said work items are inputted to said enhanced WBS design tool; and

a project management tool for receiving said structured data from said enhanced WBS design tool so as to make project management.

According to another aspect of the present invention, there is provided a method for implementing an enhanced WBS design, comprising:

implementing graphical tree-like design of the work items included in a project and their relations, and mapping them into an enhanced WBS data structure;

defining and editing attributes of work items at each node of the tree-like architecture; and

storing and managing data constructed in accordance with said enhanced WBS data structure.

According to further aspect of the present invention, there is provided a method that uses above-mentioned method for implementing an enhanced WBS design to make project design and management, comprising:

performing system design of a project so as to produce at least one work item;

performing an enhanced WBS design based on said work items; and

performing project management based on data constructed in accordance with said enhanced WBS design.

In the present invention, the attributes of said work items comprise skill requirements, resource requirements, design artifact and association relations.

In the present invention, said association relation determines whether two work items will be executed sequentially or parallelly.

In the present invention, said attributes of a work item further comprise design attachments related to the work item.

In the present invention, said constructed data are stored and managed in the form of files.

The method and tool provided by the present invention can help to connect the architect's system design work and the project manager's project management work, making it possible to reduce difficulty, time and effort for the project manager to collect work tasks, so that the efficiency of implementing and managing the project may be raised.

### BRIEF DESCRIPTION OF THE DRAWINGS

FIG. 1 shows an example of WBS in the prior art;

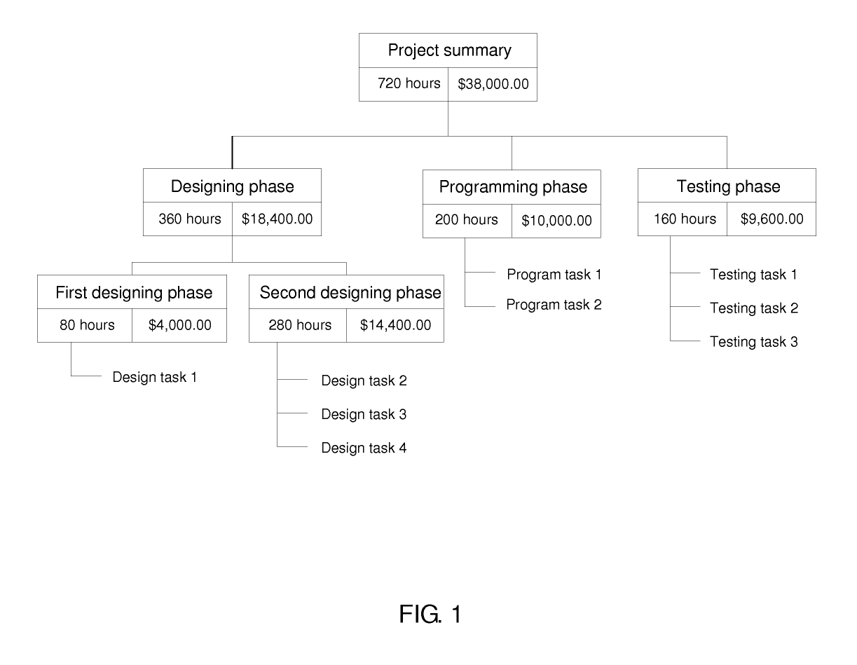

FIG. 2 is a block diagram showing the architecture of a project design and management system according to a preferred embodiment of the present invention;

FIG. 3 shows an enhanced WBS data structure adopted by the enhanced WBS design tool shown in FIG. 2 according to a preferred embodiment of the present invention;

FIGS. 4(1) and 4(2) shows the execution sequence of all sub-tasks at a task node in the enhanced WBS data structure of the present invention;

FIG. 5 shows a simplified example of system design of a Web site;

FIG. 6 shows the Gannt chart of the Web site construction project shown in FIG. 5;

FIG. 7 is a block diagram showing the enhanced WBS design tool according to a preferred embodiment of the present invention;

FIG. 8 shows an interface of the enhanced WBS design tool according to a preferred embodiment of the present invention; and

FIG. 9 is a flowchart showing the work flow of the project design and management system according to a preferred embodiment of the present invention.

### DETAILED DESCRIPTION OF THE INVENTION

An enhanced WBS design tool of the present invention connects a system design tool and a project management tool. System architecture design will make a plan of the components in the system and their relations. The project management tool will manage the whole project.

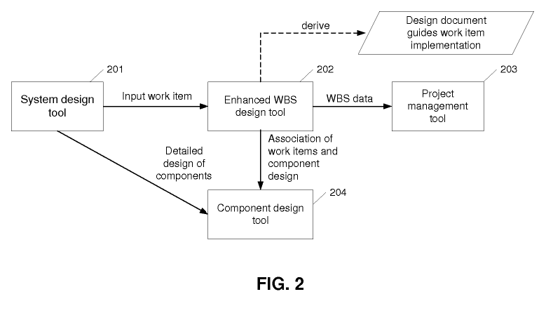

FIG. 2 shows the architecture of the project design and management system of the present invention. As shown in FIG. 2, in the present invention the system architect makes system design of a project with a system design tool 201, making the system design tool 201 output work items of the project; the enhanced WBS design tool 202 edits and manages the work items and can output WBS files as an input of the project management tool 203; and the project management tool 203 may perform detailed project plan design and control. In a preferred embodiment of the present invention, the format of an output WBS file is Microsoft Project exchange format. The WBS files in such a format are used as input of the project management tool, such as Microsoft Project.

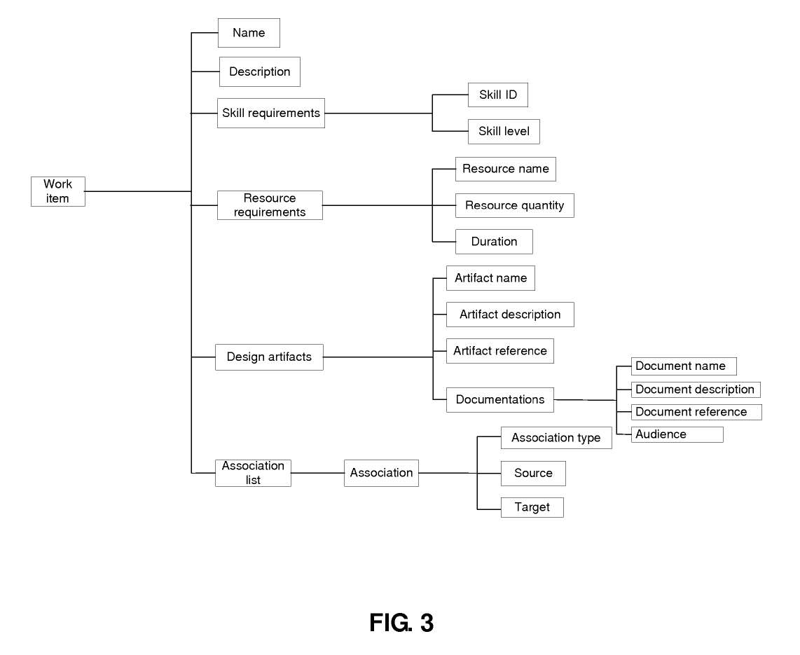

If the components involved in a work item are required to be designed in details, the enhanced WBS design tool 203 may associate the work item to the component design tool 204 for detailed design of the components and the output document/file of the components' design would be associated as a document reference of the work item. The enhanced WBS design tool 202 may package the design documents of related work items and output as task specification for guiding developers. On the other hand, if in the process of system design with the system design tool 201 the components involved in the system design are required to be designed in details, the system design tool 201 may associate to the component design tool 204 to perform detailed design of the components and the result of the components' detailed design, as an attachment, may be associated with the attribute “document reference” of the enhanced data structure of the present invention shown in FIG. 3.

In an embodiment of the present invention, said component design tool 204 may be Rational Rose, and said packaging may be implemented with Winzip.

FIG. 3 shows an enhanced WBS data structure adopted by the enhanced WBS design tool shown in FIG. 2 according to a preferred embodiment of the present invention. In FIG. 3, the enhanced WBS data structure of the invention mainly describes work items in a project and their logical relation. In order to realize the connection between system design and project management, the enhanced WBS data structure comprises:

Skill requirements required by the work tasks, used for the project manager to reasonably allocate the work to appropriate developers.

Resource requirements required by the work tasks, comprising resource name, resource quantity and time duration, used for the project manager to arrange resources.

Design artifacts related to the work tasks, comprising artifact name, artifact description, artifact reference, documentations and so forth. The design artifacts are used to produce specifications for guiding developers, wherein the documentations comprise document name, document description, document reference, audience and so on. Here the document reference may be used to indicate which documents, comprising attachments, may be used as the task's reference, and the audience indicates the persons who should have the document.

Association relation between the work tasks. There are mainly two kinds of association relation: sequence and parallel. Association relations are embodied through association type, source and target. These association relations are used to guide the production of project management chart, that is, Gannt chart.

Those skilled in the art may appreciate that the Gannt chart is a standard for the project management planning and it is well known that a project is managed in a Gannt chart, so further details are omitted for the sake of simplicity.

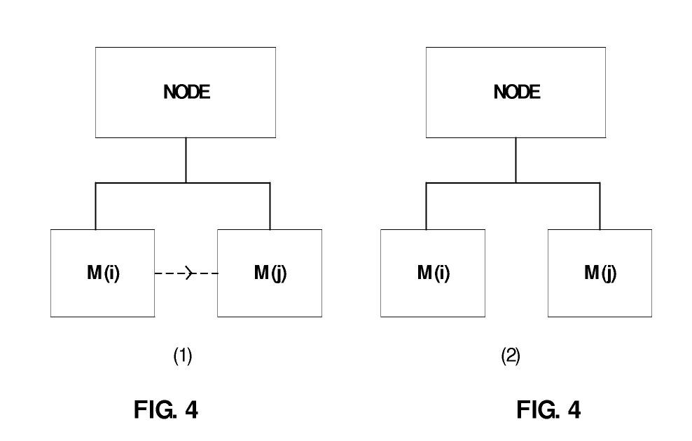

FIGS. 4(1) and 4(2) shows the execution sequence of all sub-tasks at a task node in the enhanced WBS data structure of the present invention. Specifically, in FIG. 4(1), a task node NODE has two sub-tasks M(i) and M(j), between which a dashed-line arrow represents that the sub-task M(j) is to be performed after completion of the sub-task M(i); while in FIG. 4(2), two sub-tasks M(i) and M(j) of the task node NODE may be performed in parallel. In the enhanced WBS data structure of the present invention, such execution relation between tasks is defined by the attribute “association relation” in the data structure.

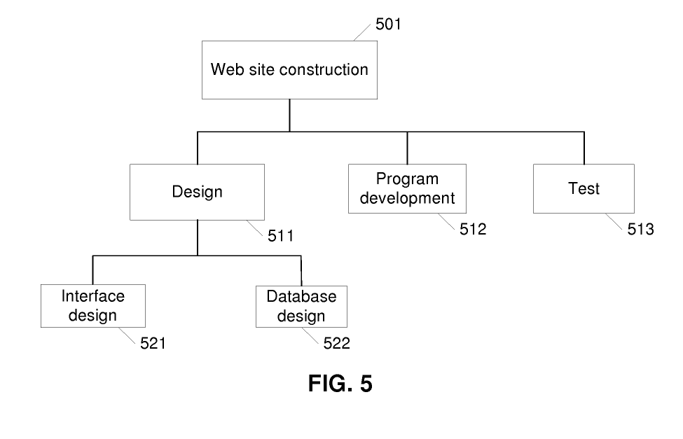

FIG. 5 to 7 shows a simplified example of system design of a Web site, wherein the system design comprises two parts: the interface design and the database design. Those skilled in the art will appreciate that the system design is simplified for illustrating the objective of the invention and should not be considered as a limitation to the invention.

The system architect, based on above-mentioned design, defines a WBS tree-like structure as shown in FIG. 5. In FIG. 5, a project 501 for Web site construction comprises three main work items: design 511, program development 512 and test 513. Two sub-items are broken down from the design 511: interface design 521 and database design 522. The enhanced WBS data structure of the invention is used to describe each work item. Taking program development 512 as an example, it cannot begin before completion of design 511, the data structure corresponding to FIG. 3 is specifically described as follows:

Task Name: Program Development

Task description: completing program development based on the result of system design.

Skill Requirements:

| | | |
|---|---|---|
| 1. | Skill ID: HTML | Skill level: 5 |
| 2. | Skill ID: J2ee | Skill level: 4 |
| 3. | Skill ID: SQL | Skill level: 4 |

Resource Requirements:

| | | | |
|---|---|---|---|
| i. | Name: Web developer | Quantity: 2 | Duration: 2 weeks |
| ii. | Name: Database developer | Quantity: 1 | Duration: 2 weeks |

Design Artifact:

i. Artifact name: HTML Form

ii. Artifact description: Design of an interface

iii. Artifact reference: Design. zip

iv. Documentations:
1. Document name: HTMLDesign
2. Document description: HTML Design Document
3. Document reference: Design.doc
4. Audience: Developer

Association List:

i. Association

ii. Association type: Sequence

iii. Source: Design (work item)

iv. Target: Program development (work item)

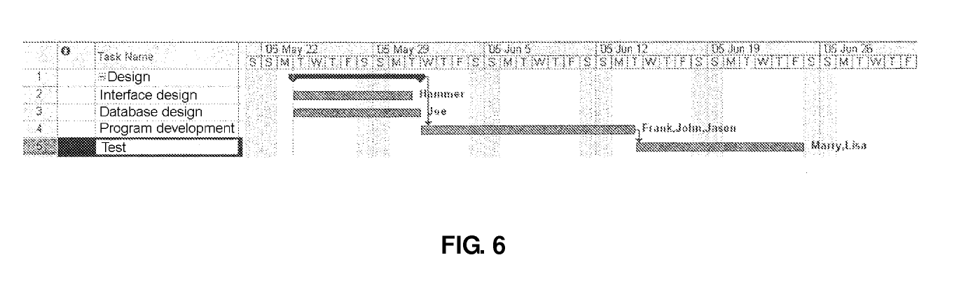

The data produced by the enhanced WBS design tool of the invention based on said enhanced WBS data structure may be in the form of a file. The data may be imported to the project management tool 203 for the project manager to make further design, comprising specific allocation of the personnel, arrangement of schedule and so on, and finally a project management Gannt chart, as shown in FIG. 6, may be obtained. The Gannt chart shows a plan for the whole project. In FIG. 6, two tasks are included in the project “design”, that is, the interface design and the database design, both of them begin at the same time, performed by Hammer and Joe, respectively. When the project “design” is finished, the project “program development” would begin, which is performed by Frank, John and Jason in two weeks. After that, Marry and Lisa would begin the test work.

A work item at each leaf node of the invention may be converted to a task in Gannt chart by the project management tool.

In the example of FIG. 5, leaf work items comprise interface design 521, database design 522, program development 512 and test 513. The project manager may make reference to attributes of each work item in WBS to define details of project management. For instance, according to the definition of WBS, program development 512 requires two persons for network program development and one person for database development to work two weeks. In the Gannt chart, completion time of the project is automatically defined as two months and the beginning of the task depends on the completion of design 511. The project manager would arrange Frank, John and Jason to participate in the task based on related skill requirements. The rest work items may be performed like this, so as to realize the final Gannt chart design. Following is a corresponding relationship between WBS and Gannt chart data structures:

| WBS attribute | | Gannt attribute |
|---|---|---|
| Name | corresponding to | Name |
| Duration | corresponding to | Duration |
| Association | converted to | Predecessors |
| Resources | converted to | Resources |

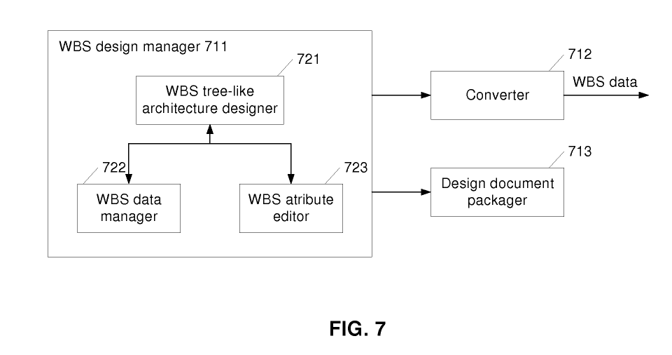

FIG. 7 is a structural block diagram showing the enhanced WBS design tool 202 according to a preferred embodiment of the present invention. As shown in FIG. 7, the WBS design tool 202 of the present invention comprises a WBS design managing means 711 and converter 712. Furthermore, a design document packager 713 is included. Wherein, the WBS design managing means 711 comprises: a WBS tree-like architecture designing means 721 used to make graphical tree-like design of the work items and their relations obtained during the phase of project design, and map them into an enhanced WBS data structure. The WBS tree-like architecture designing means 721 can provide tools for creating and editing a tree-like architecture, comprising: to divide, move, copy, and delete a work task node, to set association relation between work task nodes, to arrange and display a tree-like architecture and so on; a WBS attribute editing means 723 used to define and edit attributes of the work items at each node of the tree-like structure, wherein the WBS attribute editing means 723 may set and modify detailed information of any work task node of the tree-like architecture (according to the requirements of the enhanced WBS data structure), comprising adding attachments to the design document as a guide for implementing the work task; and a WBS data managing means 722 used to store and manage data based on the enhanced WBS data structure. The WBS data designed through the WBS tree-like architecture designing means 721 and the WBS attribute editing means 723 need to be stored and managed in computer's memories and storages (stored in hard disks in the form of files) to support version control, backup, file import/export systems and other functions. The WBS design managing means 711 connects to the converter 712 to realize data exchange with the project management tool 203. The converter 712 is used to convert the data based on the enhanced WBS data structure into data that have WBS structure required by the project management tool, and the design document packager 713 is used to package the design documents and results related to each work item. The WBS design managing means and other system design tool environment interact to each other and are integrated together.

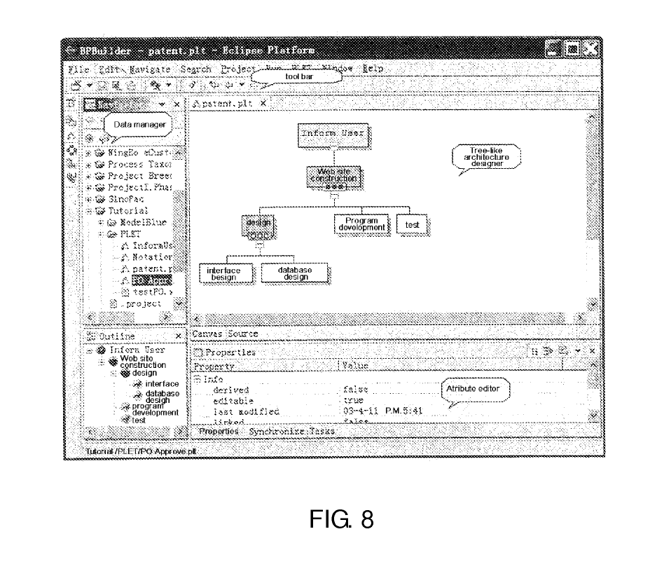

FIG. 8 shows an interface of the enhanced WBS design tool, with the Web site design shown in FIG. 5 as an example, according to a preferred embodiment of the present invention. In FIG. 8, there is a WBS tree-like architecture design window, a WBS attribute editing means window and a WBS data managing means window, as well as tool bars. Those skilled in the art will appreciate that, specific details of windows and tool bars are well known techniques in the art and further details are omitted. In the WBS tree-like architecture designing means's window of FIG. 8, the tree-like architecture of the Web site construction in FIG. 5 is shown. As mentioned above, operators may design the tree-like architecture in this window, for instance, by deleting the work item “database design”, so that the node “design” only comprises one leaf node “interface design”.

Besides, the converter 712 and design document packager 713 of the invention may be integrated into the interface in the form of toolbar elements. In the interface shown in FIG. 8, the window of data managing means may manage data based on the enhanced WBS data structure in the form of files, and the window of attribute editing means may edit and define attributes of a work item. According to an embodiment of the present invention, said system design tool may be Visio or Rational Rose, said WBS attribute editing means may be Eclipse attribute editing means, said design document packager may be WinZip, and said converter may be data “derive” tool of the Microsoft tools (the data are to be converted into Microsoft Project exchange format). Those skilled in the art will appreciate that, according to the invention, obviously other types of attribute editing means, design document packagers and converters may be used, and according to the invention, those skilled in the art will appreciate that, designing other attribute editing means, design document packagers and converters in accordance with requirements is also obvious.

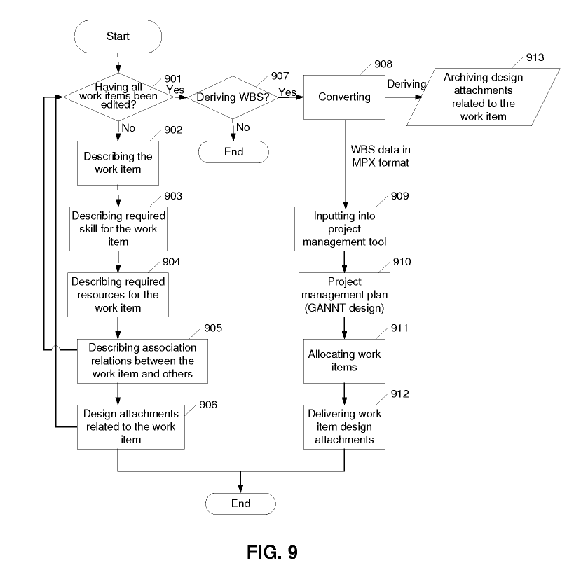

FIG. 9 is a flowchart showing the workflow of the project design and management system according to the present invention. First, the system architect designs a system structure in a system design tool based on the requirements, then each work item of any task may be obtained (not shown). After determining that not all of the work items have been edited (block 901), the system architect may use a WBS design managing means to design the work items (blocks 902 to 906). The attributes of each work item may be inputted through a WBS attribute editing means, comprising description of the work item (block 902), required skill for performing the work item (skill ID, level requirement) (block 903) and resources (resource name, resource quantity, time duration) (block 904), as well as relations between work items (block 905), wherein the correlation relations between work items, comprising sequence relation or parallel relation, may be defined through association type, source (work item) and target (work item) in the data structure of the invention. The design attachments (documents, legends and so on) related to each work item (block 906) may be inputted as attributes of a work item, such as attribute “document reference”.

After all work items have been inputted and the attributes have been edited, according to requirements (block 907), the result may be converted into data files in WBS format required by a project management tool, such as in Microsoft Project eXchange format (MPX format), and the design attachments related to each work item may be exported and archived (block 913). Data files in WBS format may be imported into the project management tool (block 909), and the project management personnel may perform an overall project plan design (complete design of a Gannt chart) (block 910) based on information on the attributes of work items. According to the plan, the project management personnel allocates the work items to related developers based on the skill requirements (block 911), and finds related design documents, legends and etc. (block 912) from the design attachment archives according to the work item ID (task name) for guiding the developers to make development.

Those skilled in the art may appreciate that, according to the illustrated description in the present specification, it is obvious how to adopt appropriate computer programming languages for implementing the concept of the present invention.

Above explanatory description to the invention has been made with some exemplary embodiments. Those skilled in the art may appreciate that various modifications and variations may be made without departing from the spirit and scope of the present invention.

1. A WBS design managing means in project management, comprising:
a WBS tree-like architecture designing means for implementing graphical tree-like design of the work items obtained in the designing phase of a project and their relations, and mapping them into an enhanced WBS data structure;
a WBS attribute editing means for defining and editing attributes of work items at each node of the tree-like architecture; and
a WBS data managing means for storing and managing data constructed in accordance with said enhanced WBS data structure.

2. The WBS design managing means according to claim 1, wherein the attributes of said work items comprise skill requirements, resource requirements, design artifacts and association relations.

3. The WBS design managing means according to claim 2, wherein said association relation determines whether two work items will be executed sequentially or parallelly.

4. The WBS design managing means according to claim 2, wherein said attributes of a work item further comprise design attachments related to the work item.

5. The WBS design managing means according to claim 1, wherein said constructed data are stored and managed in the form of files.

6. The WBS design managing means according to claim 1, wherein said constructed data may be sent to a converter so as to be converted into a format that may be inputted to a project management tool.

7. The WBS design managing means according to claim 6, wherein said constructed data may further be sent to a design document packager by said converter so that the design documents and results related to the work items can be packaged and archived.

8. The WBS design managing means according to claim 7, wherein said work items come from a system design tool for making system design of said project so as to produce at least one said work item.

9. An enhanced WBS design tool comprising the WBS design managing means of one of claims 1, further comprising:
a converter for converting said constructed data into a format required by the project management tool so as to input said constructed data into the project management tool.

10. The enhanced WBS design tool according to claim 9, wherein said project management tool produces a Gannt chart based on attribute information of said work items.

11. The enhanced WBS design tool according to claim 9, further comprising:
a design document packager for packaging and archiving the design documents and results related to the work items.

12. The enhanced WBS design tool according to claim 9, wherein said work items come from a system design tool for making system design of said project so as to produce at least one said work item.

13. The enhanced WBS design tool claimed in claim 9, further comprising:
a system design tool for making system design of said project so as to produce at least one said work item, said work items are inputted to said enhanced WBS design tool; and
a project management tool for receiving said structured data from said enhanced WBS design tool so as to make project management.

14. The system according to claim 13, further comprising:
a component design tool for designing components involved by said system design tool.

15. The system according to claim 13, wherein said attribute information of said work items is used to produce a Gannt chart by said project management tool.

16. The system according to claim 13, wherein said enhanced WBS design tool further comprises:
a design document packager for packaging and archiving the design documents and results related to the work items.

17. A method for implementing an enhanced WBS design, comprising:
implementing graphical tree-like design of the work items included in a project and their relations, and mapping them into an enhanced WBS data structure;
defining and editing attributes of work items at each node of the tree-like architecture; and
storing and managing data constructed in accordance with said enhanced WBS data structure.

18. The method according to claim 17, wherein the attributes of said work items comprise skill requirements, resource requirements, design artifact and association relations.

19. The method according to claim 18, wherein said association relation determines whether two work items will be executed sequentially or parallelly.

20. The method according to claim 18, wherein said attributes of a work item further comprise design attachments related to the work item.

21. The method according to claim 17, wherein the constructed data are stored and managed in the form of files.

22. The method according to claim 17, further comprising: sending said constructed data to a converter so as to convert them into a format that may be inputted to a project management tool.

23. The method according to claim 22, wherein further sending said constructed data to a design document packager by said converter, in which, packaging and archiving the design documents and results related to the work items.

24. The method according to claim 23, wherein said work items come from a system design tool for making system design of said project so as to produce at least one said work item.

25. The method claimed in claim 17 for implementing an enhanced WBS design to make project design and management, comprising:
performing system design of a project so as to produce at least one work item;
performing an enhanced WBS design based on said work items; and
performing project management based on data constructed in accordance with said enhanced WBS design.

26. The method according to claim 25, further comprising:
designing components involved by said system design and said enhanced WBS design.

27. The method according to claim 25, wherein producing a Gannt chart by said project management based on attribute information of said work items.

28. The method according to claim 25, wherein said enhanced WBS design further comprises:
packaging and archiving the design documents and results related to said work items.
